(19) United States
(12) Patent Application Publication
(10) Pub. No.: US 2013/0105397 A1
(43) Pub. Date: May 2, 2013

(54) MAGNETIC DYE-ADSORBENT CATALYST

(71) Applicants: Satyajit V. Shukla, Thiruvananthapuram Kerala (IN); Krishna G. Warrier, Thiruvananthapuram Kerala (IN); Manoj R. Varma, Thiruvananthapuram Kerala (IN); Madadhin T. Lajina, Thiruvananthapuram Kerala (IN); Narayani Harsha, Thiruvananthapuram Kerala (IN); Pattelath R. Chalappurath, Thiruvananthapuram Kerala (IN)

(72) Inventors: Satyajit V. Shukla, Thiruvananthapuram Kerala (IN); Krishna G. Warrier, Thiruvananthapuram Kerala (IN); Manoj R. Varma, Thiruvananthapuram Kerala (IN); Madadhin T. Lajina, Thiruvananthapuram Kerala (IN); Narayani Harsha, Thiruvananthapuram Kerala (IN); Pattelath R. Chalappurath, Thiruvananthapuram Kerala (IN)

(73) Assignee: Council of Scientific & Industrial Research, New Delhi (IN)

(21) Appl. No.: 13/521,641

(22) PCT Filed: Mar. 29, 2010
(86) PCT No.: PCT/IN2010/000198

§ 371 Date: Oct. 25, 2012

(30) Foreign Application Priority Data
Jan. 12, 2010 (IN) 67/DEL/2010

(51) Int. Cl. B01J 20/28; C02F 1/28; B01J 35/02

(52) U.S. Cl. CPC B01J 20/28016; B01J 35/026; C02F 1/28
USPC 210/663; 252/62.59

(57) ABSTRACT

New magnetic dye-adsorbent catalyst has been described in this invention, which is the modification of conventional magnetic photocatalyst. The catalyst consists of a composite particle having a core-shell structure, with a magnetic particle as a core and a dye-adsorbent (which may also exhibit photocatalytic activity) as a shell. The shell is made up of 1-dimensional (1-D) nanostructure, which enhances the specific surface-area of the conventional magnetic photocatalyst. The new magnetic dye-adsorbent catalyst removes an organic dye from an aqueous solution via surface-adsorption mechanism; while, the conventional magnetic photocatalyst uses the photocatalytic degradation mechanism.

### FIELD OF THE INVENTION

The present invention relates to preparation of a magnetic dye-adsorbent catalyst. More particularly, this invention is useful for the industrial waste-water purification involving the removal of harmful organic textile-dyes through the surface-adsorption mechanism using a high surface-area new magnetic dye-adsorbent catalyst.

### BACKGROUND OF INVENTION

Water purification via photocatalysis has gained significant attention over the past three decades. Waste-water containing textile-dyes presents a serious environmental problem due to its high toxicity which leads to ground-water and surface-water pollution (¹R. Amal, D. Beydoun, G. Low, S. Mcevoy, U.S. Pat. No. 6,558,553; ²P. A. Pekasis, N. P. Xekoukoulotakis, D. Mantzavinos, Water Research 2006, 40, 1276-1286). Further, the discharge of colored effluents into water bodies affects the sunlight penetration which in turn decreases the photosynthetic activity. Therefore, the removal of highly stable organic dyes from the textile effluents is of prime importance. The semiconductor titania (TiO₂), in the particulate form, has been the most commonly applied photocatalyst since it is inexpensive, chemically stable, and its photo-generated holes and electrons are highly oxidizing and reducing (³R. Priya, K. V. Baiju, S. Shukla, S. Biju, M. L. P. Reddy, K. R. Patil, K. G. K. Warrier, Journal of Physical Chemistry C 2009, 113, 6243-6255; ⁴A. Zachariah, K. V. Baiju, S. Shukla, K. S. Deepa, J. James, K. G. K. Warrier, Journal of Physical Chemistry C 2008; 112(30), 11345-11356; ⁵K. V. Baiju, S. Shukla, K. S. Sandhya, J. James, K. G. K. Warrier, Journal of Sol-Gel Science and Technology 2008, 45(2), 165-178; ⁶K. V. Baiju, S. Shukla, K. S. Sandhya, J. James, K. G. K. Warrier, Journal of Physical Chemistry C 2007, 111(21), 7612-7622). The organic dye removal via surface-adsorption using TiO₂ based photocatalyst, in the form of nanotubes, has also been demonstrated (⁷K. V. Baiju, S. Shukla, S. Biju, M. L. P. Reddy, K. G. K. Warrier, Catalysis Letters DOI: 10.1007/s10562-009-0010-3; ⁸T. Kasuga, H. Masayoshi, U.S. Pat. Nos. 6,027,775, 6,537,517). In terms of the reactor design, the slurry type reactors are more efficient than their immobilized counterparts.

In the literature, to ease the separation process using an external magnetic field, the pure TiO₂-based photocatalyst has been modified into a conventional “Magnetic Photocatalyst”, which possesses both the magnetic and the photocatalytic activity in comparison with the pure TiO₂-based photocatalyst which possesses only the photocatalytic activity (¹R. Amal, D. Beydoun, G. Low, S. Mcevoy, U.S. Pat. No. 6,558,553; ⁹H. Koinuma, Y. Matsumoto, U.S. Pat. No. 6,919,138; ¹⁰ D. K. Misra, U.S. Pat. No. 7,504,130)

The conventional magnetic photocatalyst is a “core-shell” composite system with a magnetic particle as a core and a photocatalyst layer as a shell. In the prior art, various magnetic materials including manganese ferrite (MnFe₂O₄), nickel ferrite (NiFe₂O₄), barium ferrite (BaFe₂O₄), cobalt ferrite (CoFe₂O₄), hematite (Fe₂O₃), magnetite (Fe₃O₄), and nickel (Ni) have been used as a core; while, the coating of TiO₂ on these magnetic particles has been popular as a shell in a conventional magnetic photocatalyst (¹¹I. A. Siddiquey, T. Furusawa, M. Sato, N. Suzuki, Materials Research Bulletin 2008, 43, 3416-3424; ¹²X. Song, L. Gao, Journal of American Ceramic Society 2007, 90(12), 4015-4019; ¹³S. Xu, W. Shangguan, J. Yuan, J. Shi, M. Chen, Science and Technology of Advanced Materials 2007, 8, 40-46; ¹⁴S. Rana, J. Rawat, M. M. Sorensson, R. D. K. Misra, Acta Biomaterialia 2006, 2, 421-432; ¹⁵H.-M. Xiao, X.-M. Liu, S.-Y. Fu, Composites Science and Technology 2006, 66, 2003-2008; ¹⁸Y. L. Shi, W. Qiu, Y. Zheng, Journal of Physics and Chemistry of Solids 2006, 67, 2409-2418; ¹⁷W. Fu, H. Yang, M. Li, L. Chang, Q. Yu, J. Xu, G. Zou, Materials Letters 2006, 60, 2723-2727; ¹⁸S.-W Lee, J. Drwiega, D. Mazyckb, C.-Y. Wu, W. M. Sigmunda, Materials Chemistry and Physics 2006, 96, 483-488; ¹⁹J. Jiang, Q. Gao, Z. Chen, J. Hu, C. Wu, Materials Letters 2006, 60, 3803-3808; ²⁰W. Fu, H. Yang, M. Li, M. Li, N. Yang, G. Zou, Materials Letters 2005, 59, 3530-3534; ²¹Y. Gao, B. Chen, H. Li, Y. Ma, Materials Chemistry and Physics 2003, 80, 348-355). The coating of TiO₂ has been developed using different techniques including sol-gel, hydrolysis/precipitation, and chemical vapor deposition (CVD). In order to avoid an electrical contact between the TiO₂ shell and the magnetic core, an insulating layer of silica (SiO₂) or a polymer is usually deposited in between the core and the shell. This intermediate layer acts as a barrier for the diffusion of core magnetic material into the photocatalyst layer during the calcination treatment and also for the photo-dissolution of the core magnetic material during the photocatalysis experiment. The sol-gel and the microwave techniques have been commonly employed for obtaining the intermediate SiO₂ layer. The noble-metal catalyst particles such as silver (Ag) and palladium (Pd) have been deposited on the top TiO₂ shell to increase the photocatalytic activity of the conventional core-shell magnetic photocatalyst system.

### Major Drawbacks of the Prior Art

1. Difficulties in removing TiO₂-based fine photocatalyst particles from the treated effluent after the completion of photocatalysis treatment. Traditional methods for the solid-liquid separation such as coagulation, flocculation, and sedimentation are tedious and expensive to apply in a photocatalytic process.

2. Additional chemicals are required and an additional purification stage needed to wash the coagulant from the photocatalyst.

3. Irrespective of morphology, the TiO₂-based photocatalyst is inherently non-magnetic, and hence, can not be separated using an external magnetic field. The approach to overcome these problems has been to develop a “core-shell” composite system, also known conventionally as a “Magnetic Photocatalyst”, which allows an easy photocatalyst removal using an external magnetic field, simplifying the downstream recovery stage.

4. The conventional magnetic photocatalyst developed so far has limited photocatalytic activity due to the presence of a core magnetic particle. As a result, the total time of dye-removal from an aqueous solution is substantially higher (in few hours).

5. The dye-removal from an aqueous solution using the conventional magnetic photocatalyst is based only on the photocatalytic degradation mechanism.

6. An energy-dependent process, that is, requiring an exposure to the ultraviolet (UV), visible, or solar-radiation, the photocatalytic degradation mechanism is an expensive process for the commercial utilization.

### Novelty of the Present Invention

1. The dye-removal via other mechanism(s) such as surface-adsorption, which is an energy-independent process, that is, requiring no exposure to the UV, visible, or solar-radiation, has never been utilized using the conventional magnetic photocatalyst. This has been mainly due to the non-suitability of the conventional magnetic photocatalyst for the surface-adsorption mechanism as a result of its lower specific surface-area.

2. The techniques to enhance the specific surface-area of the conventional magnetic photocatalyst are not yet known.

3. The techniques to coat one-dimensional nanostructures (selected from the group of nanotubes, nanowires, nanorods, nanobelts, nanofibers) of a photocatalyst on the surface of magnetic particle are not available.

4. The use of a “core-shell” composite comprising the shell of one-dimensional nanostructures (selected from the group of nanotubes, nanowires, nanorods, nanobelts, nanofibers) of a photocatalyst and the core of a magnetid particle, for an organic dye-removal from an aqueous solution has not been demonstrated.

### OBJECTIVES OF THE INVENTION

The main objective of the present invention is to provide a magnetic dye-adsorbent catalyst, which obviates the major drawbacks of the hitherto known to the prior art as detailed above.

Yet another objective of the present invention is to provide a process for the preparation of nanotubes coating of a photocatalyst as a shell on the surface of a magnetic particle as a core.

Yet another objective of the present invention is to subject the conventional magnetic photocatalyst to a hydrothermal process, which is conducive in enhancing its specific surface-area.

Yet another objective of the present invention is to develop new washing cycle following a hydrothermal process, which is conducive in enhancing the specific surface-area of the conventional magnetic photocatalyst and removing the unwanted ions present on its surface.

Yet another objective of the present invention is to develop a calcination treatment following the hydrothermal process and the subsequent washing cycle, to control the crystallinity and the phase-structure (both are required for the surface-cleaning) of the new magnetic dye-adsorbent catalyst while maintaining its dye-adsorption capacity.

Yet another objective of the present invention is to show the use of magnetic dye-adsorbent catalyst for a typical industrial application involving the removal of an organic textile-dye from an aqueous solution in the dark via surface-adsorption mechanism which is an energy-independent process.

Yet another objective of the present invention is to show quicker removal of an organic textile-dye from an aqueous solution in the dark using the magnetic dye-adsorbent catalyst relative to that using the conventional magnetic photocatalyst.

Yet another objective of the present invention is, to show the surface-cleaning of magnetic dye-adsorbent catalyst for removing the previously adsorbed organic dye in an aqueous solution, via photocatalytic degradation mechanism, using the UV, visible, or solar-radiation and to restore its maximum dye-adsorption capacity for the next dye-adsorption cycles.

Yet another objective of the present invention is to show that magnetic dye-adsorbent catalyst is suitable for the magnetic separation from an aqueous solution after the dye-removal process.

### SUMMARY OF THE INVENTION

Accordingly, the present invention provides a process for the preparation of new magnetic dye-adsorbent catalyst, useful for the industrial waste-water purification involving the removal of harmful organic textile-dyes through the surface-adsorption mechanism using the new magnetic dye-adsorbent catalyst. The conventional TiO₂-coated SiO₂/CoFe₂O₄—Fe₂O₃ magnetic photocatalyst are first processed via processes known in prior art. This conventional magnetic photocatalyst is then subjected to a hydrothermal process, which is carried out in a highly alkaline aqueous solution, under high temperature and high pressure conditions, using an autoclave having a Teflon-beaker placed in (or Teflon-lined) stainless-steel vessel. The hydrothermally processed TiO₂-coated SiO₂/CoFe₂O₄—Fe₂O₃ magnetic photocatalyst particles are then subjected to a washing cycle to obtain a new magnetic dye-adsorbent catalyst having higher specific surface-area. Optionally, the new magnetic dye-adsorbent catalyst is then subjected to a calcination treatment at higher temperature to control its crystallinity and the phase-structure so as to make its suitable for the surface-cleaning and the recycling. The washed and the calcined new magnetic dye-adsorbent catalyst are then successfully used to remove an organic textile-dye from an aqueous solution via surface-adsorption mechanism.

In one embodiment of the present invention, new magnetic dye-adsorbent catalyst comprises (a) the core of a magnetic material selected from the group consisting CoFe₂O₄, MnFe₂O₄, NiFe₂O₄, BaFe₂O₄, Fe₂O₃, Fe₃O₄, Fe, Ni; and mixture thereof, and (b) the nanostructure shell of a semiconductor material, and (c) an insulating layer in between the magnetic core and the nanostructure shell, selected from the group consisting SiO₂ and an organic polymer selected from the group containing amines (for example, polyethyleneimine (PEI, molecular weight=1800 g·mol⁻¹)) or from the group containing ether and hydroxyls (for example, hydroxypropyl cellulose (HPC, molecular weight=80,000-1,000,000 g·mol⁻¹)).

In one embodiment of the present invention, nanostructure shell of the material ranges between 5-50 wt. %, insulating layer ranges between 5-35 wt. % and the remaining being core of a magnetic material.

In one embodiment the semiconductor material is selected from the group consisting TiO₂, ZnO, SnO₂, ZnS, CdS or any other suitable semiconductor material.

In another embodiment of the present invention, the TiO₂-coated SiO₂/CoFe₂O₄—Fe₂O₃ magnetic particles were obtained using the titanium hydroxide (Ti(OH)₄) precursor.

In another embodiment of the present invention, the TiO₂-coated SiO₂/CoFe₂O₄—Fe₂O₃ magnetic particles were obtained using the titanium(IV) iso-propoxde (Ti(OC₂H₅)₄) precursor.

In another embodiment of the present invention, CoFe₂O₄ is preferred as a magnetic core.

In still another embodiment of the present invention, said insulating layer in between the core and shell is SiO₂.

In still another embodiment of the present invention, TiO₂ is preferred as a nanostructure shell.

In still another embodiment of the present invention, the nanostructure morphology of shell is selected from the group of nanotubes, nanowires, nanorods, nanobelts, and nanofibers.

In still another embodiment of the present invention, the nanotube morphology of shell is preferred.

In still another embodiment of the present invention, the internal and outer diameters of nanotubes are in the range of 4-6 nm and 7-10 nm respectively.

In still another embodiment of the present invention, there is provided a process for the preparation of new magnetic dye-adsorbent catalyst, which involves subjecting the conventional magnetic photocatalyst to a hydrothermal process, comprising the steps:
I. providing a conventional magnetic photocatalyst;
II. suspending the conventional magnetic photocatalyst in a highly alkaline aqueous solution of pH ranging from 11-14, to obtain a suspension;
III. continuous stirring of suspension obtained in step (II) in an autoclave under an autogenous pressure and at a temperature ranging between 80-200° C. for a period ranging between 1-40 h to obtain reaction product;
IV. cooling the reaction product obtained in step (III) naturally to room temperature;
V. separating the product after cooling from the solution by centrifuge at 1500-2500 rpm;
VI. washing hydrothermal product obtained in step (V) with 0.1-1.0 M HCl solution;
VII. repeating the washing of the product obtained in step (VI) with water till the final pH of filtrate is equal to that of neutral water to obtain the new magnetic dye-adsorbent catalyst;
VIII. drying the product as obtained from step (VII) in an oven at 60-90° C. for a period ranging between 10-12 hrs and then optionally calcining at a temperature ranging between 250-600° C. for a period ranging between 1-3 hrs to control the crystallinity and the phase-structure of the new magnetic dye-adsorbent catalyst.

In still another embodiment of the present invention, a new magnetic dye-adsorbent catalyst is used with or without the calcination treatment for the potential industrial application such as an organic dye-removal from an aqueous solution via surface-adsorption mechanism.

In still another embodiment of the present invention, a process for the removal of an organic-dye from an aqueous solution using the new magnetic dye-adsorbent catalyst comprising the steps of;
(i) suspending the new magnetic dye-adsorbent catalyst in an aqueous solution of an organic-dye;
(ii) mechanically stirring the suspension continuously for 10-180 min in the dark to allow the catalyst to adsorb the dye; (iii) separating the surface adsorbed dye catalyst obtained in step (ii) using an external magnetic field to obtain dye free aqueous solution.

In an embodiment the amount of catalyst suspended in aqueous solution in step (i) of the process for the removal of an organic-dye from an aqueous solution ranges from 0.5-4.0 g L⁻¹ and the amount of dye in water ranges from 7.5-60 μmol·L^{-1.}

In still another embodiment of the present invention, process for the removal of an organic-dye is conducted in the basic pH range 7-14 for the cationic organic-dyes and in an acidic pH-range 1-7 for the anionic organic-dyes.

In still another embodiment of the present invention, new magnetic dye-adsorbent catalyst is reused as a catalyst for 5 cycles of an organic dye-removal from an aqueous solution via surface-adsorption mechanism in dark.

In still another embodiment of the present invention a process for surface-cleaning of new magnetic dye-adsorbent catalyst to remove the previously adsorbed organic-dye for further reuse, comprising the steps of:
(i) suspending the new magnetic dye-adsorbent catalyst with the surface-adsorbed dye in pure distiller or de-ionized water;
(ii) adjusting the solution-pH in an acidic region ranging from 1 to 6 for anionic organic dyes or basic region ranging from 8 to 14 for cationic organic dyes
(iii) mechanically stirring the suspension obtained in step (ii) continuously under UV, visible, or solar radiation for a period ranging between 1-10 h;
(iv) changing the pure distilled (or de-ionized) water in step (i) periodically after 1-3 h time interval till removal of organic dye for achieving faster and complete removal of the surface-adsorbed dye via photocatalytic degradation mechanism.

In an embodiment the pH in step (ii) is maintained by use of a suitable acid or alkali as may be the case. In still another embodiment of the present invention, a new magnetic dye-adsorbent catalyst is characterized using various analytical techniques such as high-resolution transmission electron microscope (HRTEM), selected-area electron diffraction (SAED), fourier transform infrared (FTIR) spectrometer, X-ray diffraction (XRD), and vibrating sample magnetometer.

### BRIEF DESCRIPTION OF DRAWINGS

The present invention is illustrated in FIGS. 1 to 20 of the drawing(s) accompanying this specification. In the drawings like reference numbers/letters indicate corresponding parts in the various figures.

FIG. 1: represents typical transmission electron microscope (TEM) image of the CoFe₂O₄—Fe₂O₃ magnetic particles. The corresponding SAED pattern is shown as an inset.

FIG. 2: represents the XRD pattern obtained for the CoFe₂O₄—Fe₂O₃ magnetic particles. CF and H represent CoFe₂O₄ and Fe₂O₃.

FIG. 3: represents typical TEM images, at lower (a) and higher (b) magnifications, of the sol-gel TiO₂-coated SiO₂/CoFe₂O₄—Fe₂O₃ (R=5 and hydroxide-precursor) magnetic particles, obtained after the calcination at 600° C. for 2 h. The arrows indicate the TiO₂-coating.

FIG. 4: represents TEM (a,b) and high-resolution TEM (HRTEM) (c) images, of hydrothermally processed product obtained after the calcination treatment. CFH represents CoFe₂O₄—Fe₂O₃ magnetic particle.

FIG. 5: represents FTIR analyses of TiO₂-coated. SiO₂/CoFe₂O₄—Fe₂O₃ (R=5 and hydroxide-precursor) magnetic particles before (i) and after (ii) the hydrothermal treatment (calcined product).

FIG. 6: represents digital photographs of methylene blue (MB) dye solution, taken after definite intervals of time (as marked in minutes), after stirring the solution in dark with the dispersed particles. (a) CoFe₂O₄—Fe₂O₃; (b) SiO₂/CoFe₂O₄—Fe₂O₃; and (c) TiO₂-coated SiO₂/CoFe₂O₄—Fe₂O₃ (R=5 and hydroxide-precursor) magnetic particles. All powders are calcined at 600° C. for 2 h and used before the hydrothermal treatment.

FIG. 7: represents digital photographs of MB dye solution, taken after definite intervals of time (as marked in minutes), after stirring the solution in dark with dispersed particles. (a) CoFe₂O₄—Fe₂O₃; (b) SiO₂/CoFe₂O₄—Fe₂O₃; and TiO₂-coated SiO₂/CoFe₂O₄—Fe₂O₃ (R=5 and hydroxide-precursor) magnetic particles after (c) washing and (d) calcination. All powders are subjected to the hydrothermal treatment, then washed, and calcined (except the powder in (c)) at 400° C. for 1 h.

FIG. 8: represents the variation in the amount of surface-adsorbed MB dye as a function of stirring time in the dark. (i) CoFe₂O₄—Fe₂O₃; (ii) SiO₂/CoFe₂O₄—Fe₂O₃; and (iii) TiO₂-coated SiO₂/CoFe₂O₄—Fe₂O₃ (R=5 and hydroxide-precursor) magnetic particles. All powders are calcined at 600° C. for 2 h and used before the hydrothermal treatment.

FIG. 9: represents the variation in the normalized concentration of surface-adsorbed MB dye as a function of stirring time in the dark. (i) CoFe₂O₄—Fe₂O₃; SiO₂/CoFe₂O₄—Fe₂O₃; and TiO₂-coated SiO₂/CoFe₂O₄—Fe₂O₃ (R=5 and hydroxide-precursor) after (iii) washing, and (iv) calcination. All powders are subjected to the hydrothermal treatment, then washed, and calcined (except the powder in (iii)) at 400° C. for 1 h.

FIG. 10: Variation in the induced magnetization (B) as a function of applied field strength (H) at 270 K as obtained for the conventional magnetic photocatalyst (R=5) (a) and the new magnetic dye-adsorbent catalyst, washed (b) and calcined (c) samples.

FIG. 11: represents the XRD pattern obtained for the pure-CoFe₂O₄ magnetic particles. CF represents pure-CoFe₂O₄.

FIG. 12: represents digital photographs of MB dye, solution, taken after definite intervals of time (as marked in minutes), after stirring the solution in the dark with the dispersed TiO₂-coated SiO₂/CoFe₂O₄ (R=10 and alkoxide-precursor) magnetic particles. The photographs are obtained for the powders before (a) and after (c, d) the hydrothermal treatment. The powders have been washed (c) and then calcined at 400° C. (d) for 1 h after the hydrothermal process.

FIG. 13: represents the variation in the normalized concentration of surface-adsorbed MB dye as a function of stirring time in the dark. The graphs correspond to the TiO₂-coated SiO₂/CoFe₂O₄ (R=10 and alkoxide-precursor) magnetic particles obtained before (i) and after (ii,iii) the hydrothermal treatment. The powders have been washed (ii) and calcined at 400° C. for 1 h (iii) after the hydrothermal process.

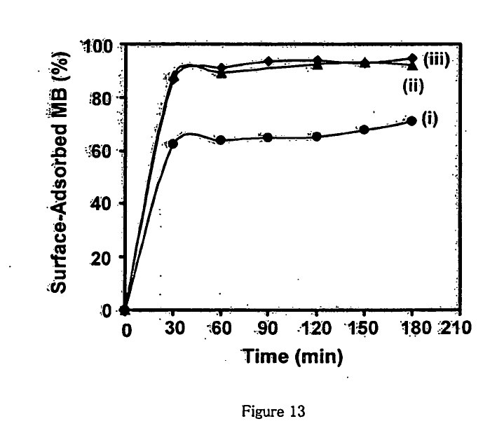

FIG. 14: represents the variation in the normalized concentration of surface-adsorbed MB dye as a function of stirring time in the dark. (a) The graphs (i)-(v) respectively correspond to the cycle-1 to cycle-5 of the dye-adsorption experiments conducted using the new magnetic dye-adsorbent catalyst (R=10 and alkoxide-precursor) obtained after the hydrothermal treatment. The powder is washed and calcined at 400° C. for 1 h after the hydrothermal process. (b) The graph (vi) corresponds to the new magnetic dye-adsorbent catalyst (R=10 and alkoxide-precursor), which is surface-cleaned using the photocatalytic activity under the solar-radiation after the completion of cycle-5.

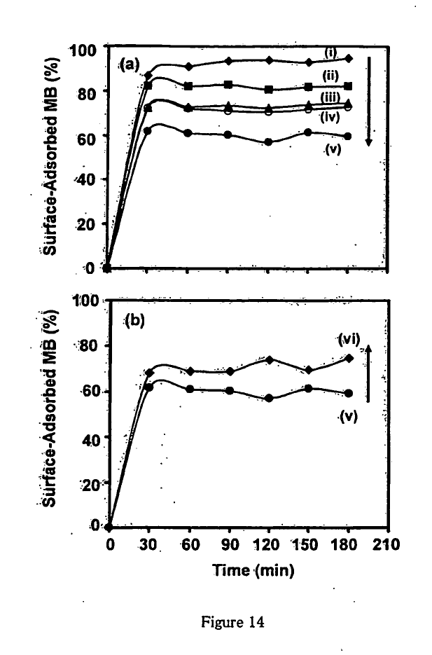

FIG. 15: represents the variation in the normalized concentration of surface-adsorbed MB dye as a function of stirring time in the dark as obtained for the new magnetic dye-adsorbent catalyst (calcined-sample) (a) and the conventional magnetic photocatalyst (calcined-sample) (b). The graphs (i)-(v) respectively correspond to the cycle-1 to cycle-5 of the dye-adsorption experiments in the dark, which were conducted under the basic condition (pH^{˜}10) for both the samples.

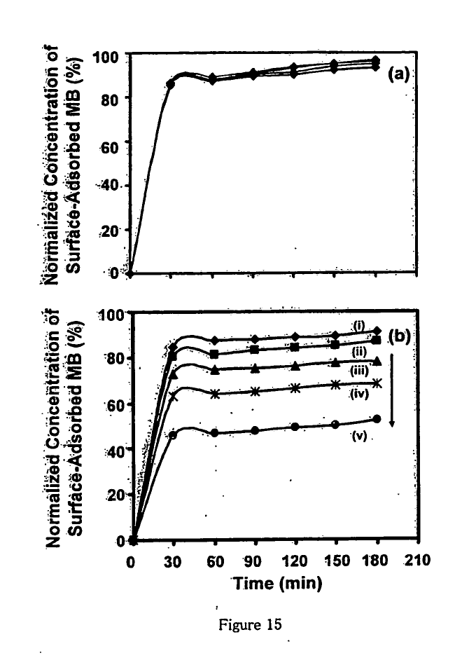

### DETAILED DESCRIPTION OF THE INVENTION

The present provides a new magnetic dye-adsorbent catalyst, which comprises processing the magnetic particles via conventional polymerized complex technique; in this process, citric acid is first dissolved in ethylene glycol (in molar ratio of 1:4) to get a clear solution; stoichiometric amounts of cobalt(II) nitrate (Co(NO₃)₂.6H₂O) and iron(III) nitrate (Fe(NO₃)₃.9H₂O) were added to the above solution and stirred for 1 h; the resulting solution was then heated in an oil bath under stirring; the yellowish gel thus obtained was charred in a vacuum furnace; a black colored solid precursor was obtained, which was then ground in an agate mortar and heat treated to obtain a mixture of cobalt ferrite (CoFe₂O₄) and hematite (Fe₂O₃) particles; the CoFe₂O₄—Fe₂O₃ magnetic powder was again calcined at higher temperature to remove the Fe₂O₃ phase and to obtain pure-CoFe₂O₄ powder; the CoFe₂O₄—Fe₂O₃ magnetic particles are then coated with a thin layer of SiO₂ as an insulating layer via conventional Stober process; in this process, ammonium hydroxide (NH₄OH) was first added to 2-Propanol under continuous mechanical stirring; followed by the addition of CoFe₂O₄—Fe₂O₃ magnetic particles under the continuous mechanical stirring; tetraethylorthosilicate (TEOS) was then added drop wise and the resulting suspension was stirred for sufficient amount of time; SiO₂/CoFe₂O₄—Fe₂O₃ magnetic particles were separated from the suspension using a centrifuge and washed with 2-Propanol and water and dried in an oven overnight; SiO₂/CoFe₂O₄—Fe₂O₃ magnetic particles were then used for the surface-deposition of TiO₂ as a photocatalyst via sol-gel; in this process, Ti(OH)₄ or Ti(OC₂H₅)₄ precursor was first dissolved in 2-Propanol under the continuous mechanical stirring to obtain a homogeneous solution; SiO₂/CoFe₂O₄—Fe₂O₃ magnetic particles were then introduced in this solution; another solution was prepared in which, water was added to 2-Propanol (with a definite water and hydroxide or alkoxide molar ratio, termed as R-value) and stirred under the continuous magnetic stirring; the second solution was then added drop wise to the first suspension and the resulting suspension was stirred continuously under the mechanical stirring for sufficient amount of time; TiO₂-coated SiO₂/CoFe₂O₄—Fe₂O₃ magnetic particles were then separated using a centrifuge and dried in an oven overnight; when the alkoxide-precursor was used, the sol-gel process was conducted twice at a reduced precursor concentration to avoid the homogeneous precipitation of free-TiO₂ particles and to control the thickness of TiO₂-coating; the dried particles were then calcined at higher temperature to convert the amorphous-TiO₂ coating into anatase-TiO₂ coating; the crystalline TiO₂-coated SiO₂/CoFe₂O₄—Fe₂O₃ magnetic particles (conventional magnetic photocatalyst) were then subjected for the first time to the novel hydrothermal process; in this process, the conventional magnetic photocatalyst was suspended in a highly alkaline aqueous solution having a pH ranging from 11-14, (containing sodium hydroxide (NaOH)), filled up to a 70-95 vol. % of a Teflon-beaker placed in (or Teflon-lined) stainless-steel (SS 316) vessel; the hydrothermal process was carried out an autoclave, at higher temperature ranging from 80-200° C. for sufficient amount of time preferably 1 to 40 hrs, with the continuous stirring in under an autogenous pressure; the autoclave was allowed to cool naturally to room temperature 15-25° C. and the product was separated from the solution using a centrifuge at 1500-2500 rpm; the hydrothermal process was then followed by washing cycle; the hydrothermal product was washed once using an acidic aqueous solution and then multiple times using pure distilled water till the final pH of the filtrate was equal to that of neutral water (^{˜}6-7); the washed powder was dried in an oven overnight to obtain a high surface-area new magnetic dye-adsorbent catalyst; and then calcined in a muffle furnace at higher temperature to control the crystallinity and the phase-structure of the new magnetic dye-adsorbent catalyst; the dye-removal process using the new magnetic dye-adsorbent catalyst was studied by monitoring the variation in the MB dye concentration in an aqueous solution under continuous mechanical stirring in the dark; an aqueous suspension was prepared by completely dissolving the MB dye and then dispersing the new magnetic dye-adsorbent catalyst in distilled water; the resulting suspension was stirred continuously for sufficient amount of time and small sample suspensions were taken out after definite time interval to determine the normalized concentration of surface-adsorbed MB; the particles were separated from the sample suspension using a centrifuge and the filtrate was then examined using a UV-visible spectrometer (UV-2401 PC, Shimadzu, Japan) to measure the relative concentration of MB dye remaining in the solution, which was calculated using the relationship of the form,

$${( \frac{{C}_{t}}{{C}_{0}} )}_{MB} = {( \frac{{A}_{t}}{{A}_{0}} )}_{656 n m} \qquad ( 1 )$$

where, C₀ and A₀ represent the initial MB dye concentration and the corresponding initial intensity of the major absorbance peak located at 656 nm; while, Cₜ and Aₜ represent these parameters after stirring the suspension in the dark for time ‘t’; the obtained data was then converted into the normalized concentration of surface-adsorbed MB as a function of stirring time in the dark.

$$\% {MB}_{ads} = {( 1 - \frac{{C}_{t}}{{C}_{0}} )}_{MB} \times 100 \qquad ( 2 )$$

The following examples are given by the way of illustration of the working of the invention in actual practice and should not be construed to limit the scope of the present invention in any way.

### EXAMPLE—1

In a typical procedure, 36.94 g of citric acid (S.D. Fine Chemicals Ltd., India)) was dissolved in 40 ml of ethylene glycol (S.D. fine chemicals Ltd., India) (in the molar ratio of 1:4) to get a clear solution. 17 g of cobalt(II) nitrate (Co(NO₃)₂.6H₂O, Sigma-Aldrich, India) and iron(III) nitrate (Fe(NO₃)₃).9H₂O) (47.35 g, Sigma-Aldrich, India) were added to the above solution and stirred for 1 h. The resulting solution was then heated at 80° C. for 4 h in an oil bath under continuous stirring. The yellowish gel thus obtained was charred at 300° C. for 1 h in a vacuum furnace. A black colored solid precursor was obtained, which was then ground in an agate mortar and heat treated at 600° C. for 6 h.

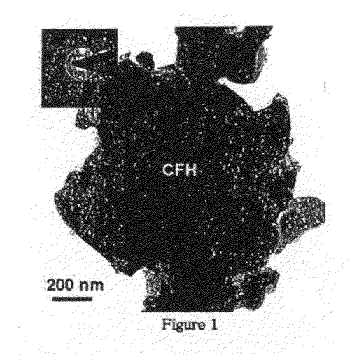

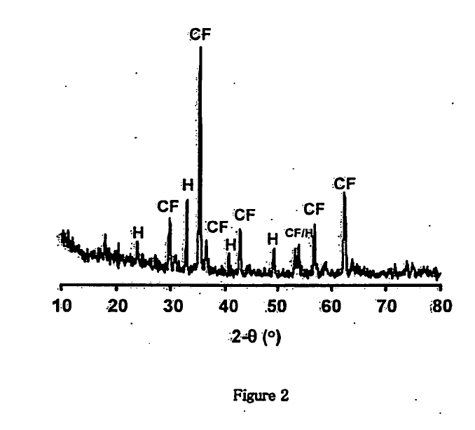

The TEM micrograph of the obtained powder is shown in FIG. 1, where the aggregate size as large as ^{˜}1 μm is noted. The edges magnetic particles are relatively straight, smooth, and featureless. The corresponding SAED pattern is shown as an inset in FIG. 1, which shows the crystalline nature of the aggregated particle. The crystalline phases have been identified by obtaining the XRD pattern, which is presented in FIG. 2. The XRD peaks have been identified to correspond to those of CoFe₂O₄ (JCPDS card no. 22-1086) and Fe₂O₃ (JCPDS card no. 33-663). Hence, the magnetic powder consists of a mixture of CoFe₂O₄ and Fe₂O₃.

The CoFe₂O₄—Fe₂O₃ magnetic powder was again calcined at 900° C. for 4 h to completely remove the Fe₂O₃ phase and to obtain pure-CoFe₂O₄ magnetic powder. The CoFe₂O₄—Fe₂O₃ magnetic powder is used in this example; while, the pure-CoFe₂O₄ magnetic powder is used in the Example—2.

The CoFe₂O₄—Fe₂O₃ magnetic particles were then coated with a thin layer of SiO₂ as an insulating layer via conventional Stober process. In this process, 1.0 ml of ammonium hydroxide (NH₄OH, 25 wt. %, S.D. Fine Chemicals Ltd., India) was added to 250 ml of 2-Propanol (S.D. Fine Chemicals Ltd., India) under the continuous mechanical stirring. This was followed by the addition of 2.0 g of CoFe₂O₄—Fe₂O₃ magnetic particles under the continuous mechanical stirring. 7.3 ml of tetraethylorthosilicate (TEOS, Aldrich, India) was then added drop wise and the resulting suspension was stirred continuously for 3 h. The 50 wt. % SiO₂/CoFe₂O₄—Fe₂O₃ magnetic particles were separated from the suspension using a centrifuge and washed with 2-Propanol and water followed by drying in an oven at 80° C. overnight.

SiO₂/CoFe₂O₄—Fe₂O₃ magnetic particles were then used for the surface-deposition of 40 wt. % TiO₂ as a photocatalyst via sol-gel. In this process, 4.73 g of Ti(OH)₄ precursor (Note: This precursor was obtained by very slow hydrolysis of titanium(IV)-iso propoxide (Ti(OC₂H₅)₄, Aldrich, India) over several months) was first added to 125 ml of 2-Propanol under the continuous mechanical stirring to obtain a homogeneous solution. 2 g of SiO₂/CoFe₂O₄—Fe₂O₃ magnetic particles were then introduced in this solution. Another solution was prepared in which, 1.5 ml of H₂O was added to 125 ml of 2-Propanol and stirred under the continuous mechanical stirring. The second solution was then added drop wise to the first suspension and the resulting suspension was stirred continuously using the mechanical stirring for 10 h. The TiO₂-coated SiO₂/CoFe₂O₄—Fe₂O₃ magnetic particles are then separated using a centrifuge and dried in an oven at 80° C. overnight. The dried particles are then calcined at 600° C. for 2 h to convert an amorphous-TiO₂ shell into crystalline anatase-TiO₂ shell.

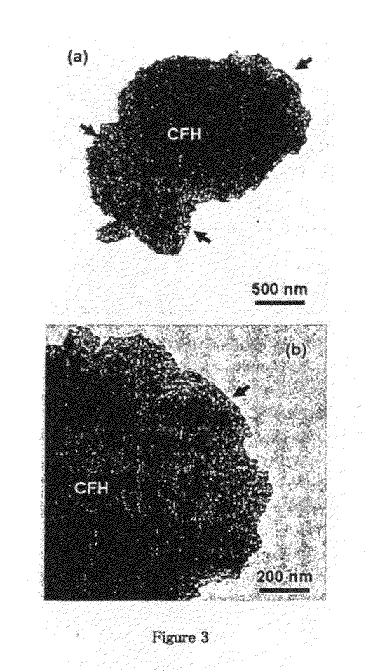

The TEM image of TiO₂-coated SiO₂/CoFe₂O₄—Fe₂O₃ magnetic particle (conventional magnetic photocatalyst) is shown in FIG. 3(a); while, higher magnification image is provided in FIG. 3(b). It shows that, after the sol-gel deposition of SiO₂ and TiO₂, the smooth and featureless magnetic particle surface becomes wavy and shows the presence of small nanoparticles, which form the TiO₂ coating on the surface of magnetic particle. The TiO₂ coating is as thick as ^{˜}200 nm as indicated by arrows with the average nanocrystallite size of ^{˜}10 nm.

The TiO₂-coated SiO₂/CoFe₂O₄—Fe₂O₃ magnetic particles, obtained via conventional processes, are then subjected for the first time, to the hydrothermal process. In this process, 0.5 g of TiO₂-coated SiO₂/CoFe₂O₄—Fe₂O₃magnetic particles were suspended in a highly alkaline aqueous solution (pH^{˜}13.4) containing 10 M NaOH (97% Assay, S.D. Fine Chemicals Ltd., India) filled up to 84 vol. % of Teflon-beaker placed in (or Teflon-lined) stainless-steel (SS 316) vessel of 200 ml capacity. The hydrothermal process was carried out with continuous stirring in an autoclave (Amar Equipment Pvt. Ltd., Mumbai, India) at 120° C. for 30 h under an autogenous pressure. Autoclave was allowed to cool naturally to room temperature and the product was separated from the solution using a centrifuge (R23, Remi Instruments India Ltd.).

The hydrothermal process was then followed by a typical washing cycle. The hydrothermal product was washed once using 100 ml of 1 M HCl (35 wt. %, Ranbaxy Fine Chemicals Ltd., India) solution (pH^{˜}0.3) for 2 h and then multiple times using 100 ml of pure distilled water till the final pH of the filtrate was equal to that of neutral water (^{˜}6-7). The washed powder was then dried in an oven at 110° C. overnight and then calcined in a muffle furnace at 400° C. for 1 h to control the crystallinity and the phase-structure of the final product.

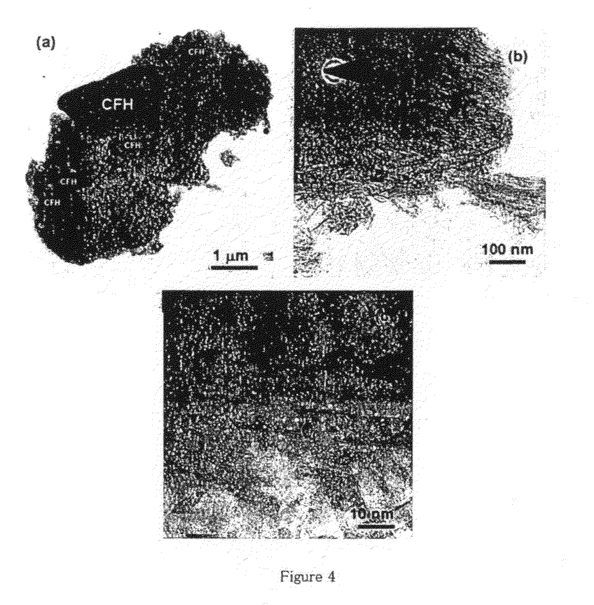

The TEM image of the particles obtained after the washing cycle is presented in FIG. 4(a); while, higher magnification images, obtained from the edge of the particle, are presented in FIGS. 4(b) and 4(c). In FIG. 4(a), the CoFe₂O₄—Fe₂O₃ magnetic particles are seen in a dark contrast. These magnetic particles are seen to be surrounded by a fibrous matrix, FIG. 4(b), which is formed as a result of hydrothermal processing and the subsequent washing cycle. Higher magnification image, FIG. 4(c), suggests that the fibrous matrix consists of small nanotubes with the internal and outer diameters of ^{˜}4.7 nm and ^{˜}8.7 nm. Thus, the initial TiO₂-coating consisting nanoparticles, FIG. 3, is converted into a coating of high surface-area nanotubes via novel hydrothermal process followed by the washing cycle.

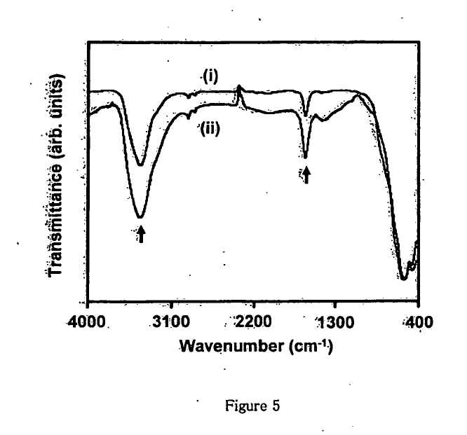

The FTIR analysis (Nicolet Impact 400D Spectrometer, Japan) of TiO₂-coated SiO₂/CoFe₂O₄—Fe₂O₃ magnetic particles, before and after the complete hydrothermal treatment (including washing cycle), is presented in FIG. 5. The absorbance peaks observed at 1630 cm⁻¹ and 3440 cm⁻¹ represent the bending vibration of H—O—H bond and stretching vibration of O—H bonds; while, those observed in lower frequency region, 400-800 cm⁻¹, have been attributed to Ti—O and Ti—O—Ti vibrations. Comparison clearly shows that, relatively larger amount of water and hydroxyls groups are adsorbed on the surface of the product obtained after the hydrothermal treatment (including the washing cycle) than those adsorbed on the surface of conventional magnetic photocatalyst. This strongly suggests that, the specific surface-area of the former is much larger (approximately 10 times) than that of the later.

The dye-removal process using the magnetic photocatalyst particles, under going different processing steps, was studied by monitoring the variation in the MB dye concentration in an aqueous solution under continuous mechanical stirring in the dark. A 75 ml of aqueous suspension was prepared by completely dissolving 7.5 μmol·L⁻¹ of MB dye and then dispersing 1.0 g·L⁻¹ of catalyst in distilled water. The resulting suspension was stirred continuously for 180 min and 3 ml sample suspension was taken out after each 30 min time interval. The powder was then separated from the sample suspension using a centrifuge and the filtrate was examined using a UV-visible spectrometer to determine the normalized concentration of MB dye adsorbed on the powder-surface.

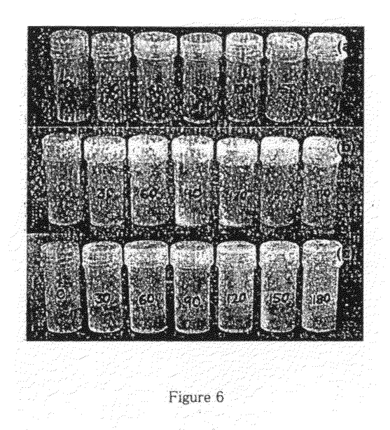

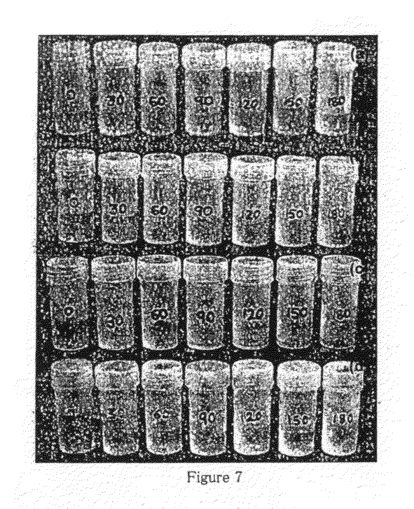

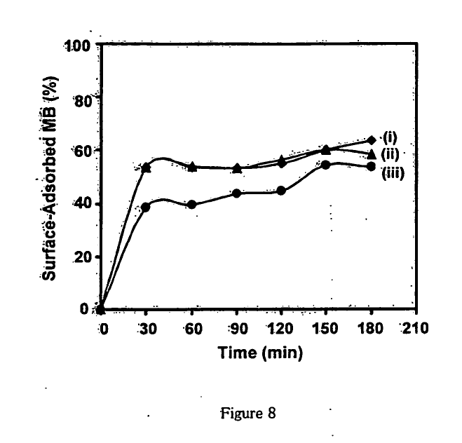

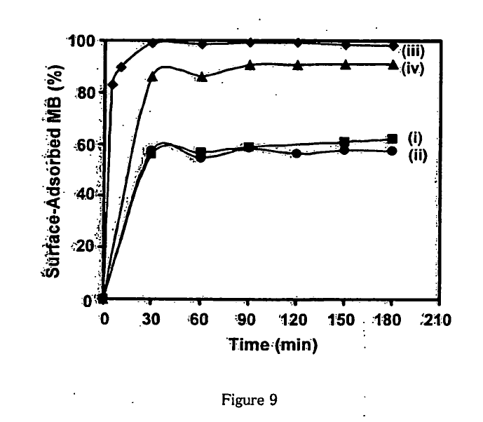

The qualitative variation in the color of an aqueous MB dye solution is presented in FIGS. 6 and 7. It is noted that, among all the samples tested, the new TiO₂-coated SiO₂/CoFe₂O₄—Fe₂O₃ magnetic dye-adsorbent photocatalyst, obtained after the hydrothermal process and the subsequent washing cycle and the calcination treatment, show very fast removal of MB dye via surface-adsorption mechanism, which is evident from the change in the bluish solution to nearly colorless solution. This has been attributed here to higher specific surface-area of these samples due to the formation of nanotubes on the surface of magnetic particles, which is confirmed via HRTEM analysis. The quantitative variation in the amount of surface-adsorbed MB dye as a function of stirring time in the dark is presented for different samples in FIGS. 8 and 9. It is noted that, the MB dye adsorption varies in between 40-60% for all the samples before and after the hydrothermal treatment, except for the dried and calcined hydrothermally processed TiO₂-coated SiO₂/CoFe₂O₄—Fe₂O₃ magnetic particles. These samples show the surface-adsorption as high as 86-99% in just 30 min of stirring time in the dark. Such high MB dye adsorption, as observed here, is a result of higher specific surface-area of the new TiO₂-coated SiO₂/CoFe₂O₄—Fe₂O₃ magnetic dye-adsorbent catalyst, due to the presence of TiO₂-coating in the form of nanotubes (either of anantase-TiO₂ or hydrogen titanates) on the surface. The particles with the surface-adsorbed MB dye could be separated from the solution using a bar magnet after the dye-adsorption process.

Thus, using a hydrothermal process and the subsequent washing cycle and calcination treatment, the initial conventional magnetic photocatalyst has been successfully converted into a new magnetic dye-adsorbent catalyst, which is successfully utilized for an organic dye-removal from an aqueous solution via surface-adsorption mechanism under the dark condition.

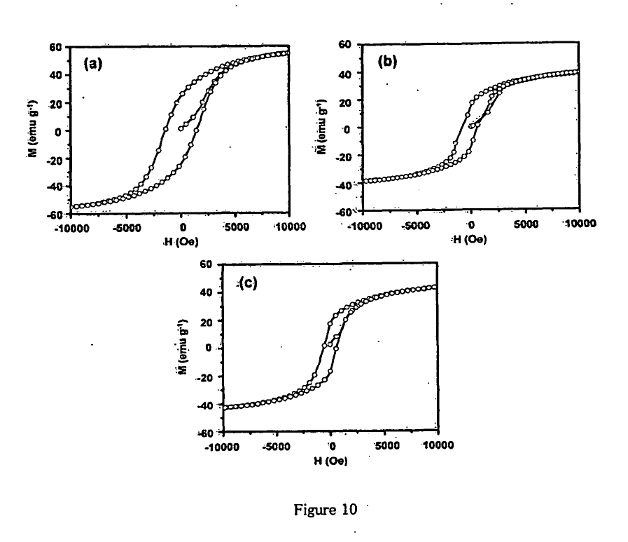

The magnetic properties of different samples were measured using a vibrating sample magnetometer (VSM) attached to a Physical Property Measurement System (PPMS). The pristine samples were subjected to different magnetic field strengths (H) and the induced magnetization (M) was measured at 270 K. The external magnetic field was reversed on saturation and the hysteresis loop was traced. The variation in the induced magnetization as a function of applied magnetic field strength, as obtained for the conventional magnetic photocatalyst and the new magnetic dye-adsorbent catalyst, is presented in FIG. 10. The presence of a hysteresis loop is noted for all the three samples, which suggests the ferromagnetic nature of these particles. The hydrothermally processed washed and dried sample, FIG. 10b, and the calcined sample, FIG. 10c, show reduced saturation magnetization, remenance magnetization, and coercivity relative to those observed for the conventional magnetic photocatalyst, FIG. 10a, possibly as a combined effect of the formation nanotubes and change in an average particle size of core magnetic particle after the hydrothermal treatment. Nevertheless, the ferromagnetic nature of the new magnetic dye-adsorbent catalyst as suggested by the presence of a hysteresis loop, does render its use for the separation from an aqueous solution using an external magnetic field.

Block diagram describing the steps involved in the conventional preparation of CoFe₂O₄—Fe₂O₃ (or pure-Fe₂O₃) magnetic particles

Block diagram describing the steps involved in the conventional Stober process for coating SiO₂ on the surface of CoFe₂O₄—Fe₂O₃ magnetic particles.

Block diagram describing the steps involved in the conventional sol-gel coating of TiO₂ on the surface of SiO₂/CoFe₂O₄—Fe₂O₃ magnetic particles.

Block diagram describing the steps involved in the novel hydrothermal treatment applied to the conventional magnetic photocatalyst

### EXAMPLE—2

In this example, pure-CoFe₂O₄ magnetic particles were used instead of CoFe₂O₄—Fe₂O₃ magnetic particles as used in the previous example. The TiO₂-coating on the surface of pure-CoFe₂O₄ magnetic particles were obtained via sol-gel using the Ti(OC₃H₅)₄ precursor with the R-value of 10 (Larger R-values normally result in the precipitation of free-TiO₂ particles without forming any coating on the surface of magnetic particles). The concentration of Ti(OC₃H₅)₄ was reduced to 0.5 g·L⁻¹ and the sol-gel process was repeated twice to obtain a thicker TiO₂-coating. 15 wt. % TiO₂ was deposited on the SiO₂/CoFe₂O₄ magnetic particles as derived from an increase in the weight of the sample. All remaining processing and test parameters were similar to those used in the previous example.

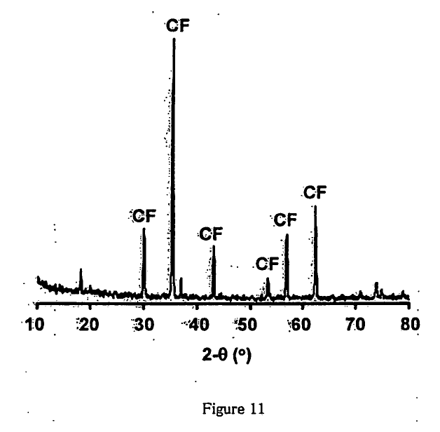

The XRD pattern obtained for the pure-CoFe₂O₄ magnetic particles is presented in FIG. 11, where the peaks are identified to correspond to those of pure-CoFe₂O₄ after comparing the pattern with the JCPDS card no. 22-1086.

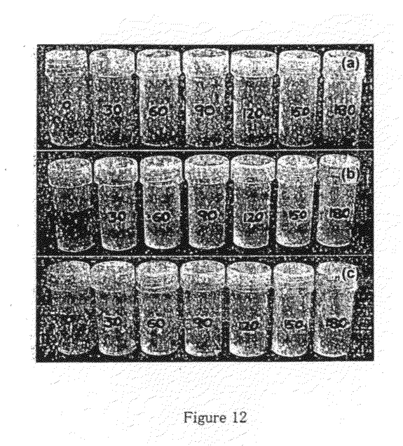

The qualitative variation in the color of an aqueous MB dye solution is presented in FIG. 12 for the TiO₂-coated SiO₂/CoFe₂O₄ magnetic particles obtained before and after the hydrothermal process (including the washing cycle and the calcination treatment). It is noted that, among the three samples tested, the TiO₂-coated SiO₂/CoFe₂O₄ magnetic particles, subjected to the hydrothermal process followed by the subsequent washing cycle and the calcination treatment, show relatively quicker removal of MB dye via surface-adsorption mechanism, which is evident from the change in the bluish solution to nearly colorless solution. This is again attributed here to higher specific surface-area of these samples due to the formation nanotubes on the surface of pure-CoFe₂O₄ magnetic particles.

The quantitative variation in the amount of surface-adsorbed MB dye as a function of stirring time in the dark is presented, for the above samples, in FIG. 8. It is noted that, the MB dye adsorption varies in between 60-70% for the conventional sol-gel TiO₂-coated SiO₂/CoFe2O₄ magnetic photocatalyst particles. However, following the hydrothermal process with the subsequent washing cycle and the calcination treatment, the amount of MB dye adsorption increases to 88-92% and 87-95% within 30-180 min of stirring time in the dark. Such high MB dye adsorption, as observed here, is a result of higher specific surface-area of the novel TiO₂-coated SiO₂/CoFe₂O₄ magnetic dye-adsorbent catalyst due to the presence of TiO₂-coating in the form of nanotubes (either of hydrogen titanates or anantase-TiO₂) on the surface of core magnetic particles. The particles with the surface-adsorbed MB dye could be separated from the solution using a bar magnet after the dye-adsorption process.

### EXAMPLE—3

In this example, the catalytic nature of the new magnetic dye-adsorbent catalyst has been demonstrated. All processing and test parameters were similar to those used in the example—2. The high surface-area new magnetic dye-adsorbent catalyst (calcined-sample) was utilized for the successive five cycles of MB dye-adsorption experiments conducted in the dark.

The quantitative variation in the normalized concentration of surface-adsorbed MB as a function of stirring time in the dark, as obtained for the different number of cycles. It is noted that, with increasing number of dye-adsorption cycles from cycle-1 to cycle-5, conducted in the dark, the maximum normalized concentration of MB dye adsorption decreases progressively from 95% to 60%. This clearly shows very high dye-adsorption capacity of the high surface-area new magnetic dye-adsorbent catalyst for the repeated number of dye-adsorption cycles.

To remove the previously adsorbed MB dye from the surface and to restore the adsorption capacity of the new magnetic dye-adsorbent catalyst, a surface-cleaning treatment has been carried out. In this, the new magnetic dye-adsorbent catalyst, with the surface-adsorbed MB dye as obtained after the cycle-5, is suspended in 100 ml of pure distilled water and stirred using a mechanical stirrer under the solar-radiation for total 6 h. The pure distilled water is replaced periodically after 2 h interval to maintain higher MB dye removal via photocatalytic degradation mechanism. The surface-cleaned new magnetic dye-adsorbent catalyst is separated from the solution via filtration, followed by drying in an oven at 110° C. and reused for the MB dye adsorption experiment as described previously.

The quantitative variation in the normalized concentration of surface-adsorbed MB as a function of stirring time in the dark, as obtained for the present new magnetic dye-adsorbent catalyst, before and after the surface-cleaning treatment, is presented in FIG. 9(b). It is clearly seen that, following the surface-cleaning treatment, the MB dye adsorption capacity increases from 60% to 75%. Thus, the decreasing trend in the dye-adsorption capacity, as observed in FIG. 9(a), is immediately reversed after the surface-cleaning treatment. Hence, the catalytic nature of the present new magnetic dye-adsorbent catalyst is successfully shown here.

It is to be noted that, the kinetics of removal of previously adsorbed MB-dye from the surface of new magnetic dye-adsorbent catalyst may be improved by adjusting the solution-pH in the basic range (^{˜}7-12) using NaOH, KOH or any other alkali.

Block diagram describing the steps involved in the novel washing cycle used for the hydrothermally processed product

### EXAMPLE—4

In this example, the effect of solution-pH on the maximum dye-adsorption capacity of new magnetic dye-adsorbent catalyst is compared with that of the conventional magnetic photocatalyst for the successive five cycles of dye-adsorption experiments conducted in the dark. The samples used were same as those used in the example—2 and 3.

The quantitative variation in the normalized concentration of surface-adsorbed MB as a function of stirring time in the dark, at pH^{˜}10 as obtained for the new magnetic dye-adsorbent catalyst (calcined-sample) and the conventional magnetic photocatalyst (calcined-sample), is presented in FIGS. 10(a) and 10(b). (Note: All other dye-adsorption results presented earlier were obtained at neutral solution-pH (^{˜}6-7)). It is observed that, under an alkaline condition, FIG. 10(a), the maximum dye-adsorption capacity of the new magnetic dye-adsorbent catalyst is higher and does not change significantly with the repeated number of dye-adsorption cycles as observed earlier at the neutral solution-pH, FIG. 9(a). On the other hand, the maximum dye-adsorption capacity of the conventional magnetic photocatalyst decreases significantly with the repeated number of dye-adsorption cycles at higher solution-pH, FIG. 10(b). Comparison of FIG. 10(a) with FIG. 9(a) further suggests that, relative to neutral solution-pH, an alkaline condition is suitable for maintaining the high dye-adsorption capacity of new magnetic dye-adsorbent catalyst for the repeated number of dye-adsorption cycles. This has been attributed to an increased electrostatic interaction between the highly negatively charged surface of high surface-area new magnetic dye-adsorbent catalyst and the cationic MB dye in an aqueous solution having the basic-pH. This further suggests that, in order to remove an anionic dye from an aqueous solution using the high surface-area new magnetic dye-adsorbent catalyst via surface-adsorption mechanism, the solution-pH should be adjusted in an acidic range.

The main advantages of the present invention are:

1 It provides new processes (sol-gel coating followed by hydrothermal and subsequent washing cycle and calcination) to coat the nanotubes on a substrate.

2 It provides new processes (hydrothermal and subsequent washing cycle and calcination) to increase the specific surface-area of the conventional magnetic photocatalyst.

3 It provides a new magnetic dye-adsorbent catalyst, having higher specific surface-area, processed using a conventional magnetic photocatalyst having lower specific surface-area.

4 It provides the surface-adsorption as a novel mechanism for an organic dye removal from an industrial waste-water due to higher specific surface-area of the new magnetic dye-adsorbent catalyst.

5 It provides the surface-adsorption as a dye-removal mechanism, which doest not need the UV, visible, or solar-radiation (energy-independent process); hence, it is relatively cost-effective process compared with the conventional photocatalytic degradation mechanism associated with the conventional magnetic photocatalyst.

6 It provides the surface-adsorption as a dye-removal mechanism, which is relatively quicker in removing an organic dye from an aqueous solution relative to the conventional photocatalytic degradation mechanism associated with the conventional magnetic photocatalyst.

7 It provides new techniques to maintain the high dye-adsorption capacity of the new magnetic dye-adsorbent catalyst for the repeated number of dye-adsorption cycles in the dark.

8 It provides a new magnetic dye-adsorbent catalyst, which can be surface-cleaned under the UV, visible, or solar-radiation to remove the previously adsorbed organic dye and reused for the large number of successive cycles of dye-removal process in the dark.

9 It provides a new magnetic dye-adsorbent catalyst which can be separated from an aqueous solution, after the dye-removal process, using an external magnetic field as it retains the ferromagnetic characteristic of the conventional magnetic photocatalyst.

We claim:

1. A magnetic dye-adsorbent catalyst comprising:
(a) core of a magnetic material selected from the group consisting of CoFe₂O₄, MnFe₂O₄, NiFe₂O₄, BaFe₂O₄, Fe₂O₃, Fe₃O₄, Fe, Ni; and mixture thereof;
(b) nanostructure shell of a semiconductor material selected from the group consisting of TiO₂, ZnO, SnO₂, ZnS, CdS or other semiconductor material; and
(c) an insulating layer in between the magnetic core and the nanostructure shell, selected from the group consisting of SiO₂ and an organic polymer.

2. The magnetic dye-adsorbent catalyst-as claimed in claim 1, wherein nanostructure shell of the material used ranges between 5-50 wt. %, insulating layer ranges between 5-35 wt. % and the remaining being core of a magnetic material.

3. The magnetic dye-adsorbent catalyst as claimed in claim 1, wherein CoFe₂O₄ is preferred as magnetic core.

4. The magnetic dye-adsorbent catalyst as claimed in claim 1, wherein TiO₂ is preferred as material for nanostructure shell.

5. A magnetic dye-adsorbent catalyst as claimed in claim 1, wherein SiO₂ is preferred as an insulating layer.

6. The new magnetic dye-adsorbent catalyst as claimed in claim 1, wherein organic polymer is selected from the group consisting of amines, polyethyleneimine, ether and hydroxyls, hydroxypropyl cellulose.

7. The magnetic dye-adsorbent catalyst as claimed in claim 1, wherein nanostructure shell has a morphology selected from the group of nanotubes, nanowires, nanorods, nanobelts, nanofibers, and other one-dimensional (1-D) nanostructures.

8. The magnetic dye-adsorbent catalyst as claimed in claim 7, wherein the nanotube has an internal and outer diameters in the range of 4-6 nm and 7-10 nm respectively.

9. A process for the preparation of new magnetic dye-adsorbent catalyst, as claimed in claim 1, comprising the steps:
(I). providing a conventional magnetic photocatalyst;
(II). suspending the conventional magnetic photocatalyst in a highly alkaline aqueous solution of pH ranging from 11-14, to obtain a suspension;
(III). continuous stirring of suspension obtained in step (II) in an autoclave under an autogenous pressure and at a temperature ranging between 80-200° C. for a period ranging between 1-40 h to obtain reaction product;
(IV). cooling the reaction product obtained in step (III) naturally to room temperature;
(V). separating the product after cooling from the solution by centrifuge at 1500-2500;rpm;
(VI). washing hydrothermal product obtained from step (V) using 0.1-1.0 M HCl; solution;
(VII). repeating the washing of the product obtained in step (VI) with water till the final pH of filtrate is equal to that of neutral water to obtain new magnetic dye-adsorbent catalyst;
(VIII). drying the product as obtained from step (VII) in an oven at 60-90° C. for a period ranging between 10-12 hrs and then optionally calcining at a temperature ranging between 250-600° C. for a period ranging between 1-3 h to control the crystallinity and the phase-structure of the new magnetic dye-adsorbent catalyst.

10. The magnetic dye-adsorbent catalyst as claimed in claim 1, with or without the calcination treatment as claimed in claim 9, useful for the industrial application such as an organic dye-removal from an aqueous, solution via surface-adsorption mechanism in the dark.

11. A process for the removal of an organic-dye from an aqueous solution using the new magnetic dye-adsorbent catalyst as claimed in claim 1, comprising the steps of;
(i). suspending the catalyst as claimed in claim 1 in an aqueous solution of an organic-dye;
(ii). mechanically stirring the suspension as obtained in step (i) continuously for 10-180 min in the dark to allow the catalyst to adsorb the dye;
(iii). separating the surface adsorbed dye catalyst obtained in step (ii) using an external magnetic field to obtain dye free aqueous solution.

12. The process as claimed in claim 11, wherein removal of an organic dye from an aqueous solution is conducted in the basic pH ranging from 7-14 for the cationic organic-dyes and in an acidic pH ranging from 1-7 for the anionic organic-dyes.

13. The magnetic dye-adsorbent catalyst as claimed in claim 1, capable of reuse as a catalyst for at least 5 cycles of an organic dye-removal from an aqueous solution via surface-adsorption mechanism in the dark.

14. A process for surface-cleaning of new magnetic dye-adsorbent catalyst to remove the previously adsorbed organic-dye for further reuse, comprising the steps of;
(a) suspending the magnetic dye-adsorbent catalyst with surface-adsorbed dye in water;
(b) adjusting the solution-pH in an acidic region ranging from 1 to 6 for anionic organic dyes or basic region ranging from 8-14 for cationic organic dyes;
(c) mechanically stirring the suspension obtained in step (b) continuously under UV, visible, or solar radiation or in dark for a period ranging between 1-10 h;
(d) changing the aqueous solution in step (a) periodically after 1-3 h time interval for achieving faster and complete removal of the surface-adsorbed dye via photocatalytic degradation mechanism.
